(19) United States
(12) Patent Application Publication
(10) Pub. No.: US 2017/0293074 A1
(43) Pub. Date: Oct. 12, 2017

(54) PHOTONIC RADIATOR FOR RADIATING LIGHT WAVE TO FREE SPACE

(71) Applicant: Korea Advanced Institute of Science and Technology, Daejeon (KR)

(72) Inventors: Hyo-Hoon Park, Daejeon (KR); Jong-Hun Kim, Daejeon (KR); Sun-Kyn Han, Daejeon (KR); Ji-Hwan Park, Daejeon (KR)

(21) Appl. No.: 15/481,928

(22) Filed: Apr. 7, 2017

(30) Foreign Application Priority Data
Apr. 8, 2016 (KR) 10-2016-0043726

(51) Int. Cl. G02B 6/124; G02B 6/122

(52) U.S. Cl. CPC G02B 6/124; G02B 6/1226

(57) ABSTRACT

A photonic radiator used for a photonic phased array antenna includes a waveguide including a waveguide clad and a waveguide core that uses semiconductor materials, and a grating that radiates an output light wave to a space by using scattering of an input light wave incident in a direction of the waveguide.

### CROSS-REFERENCE TO RELATED APPLICATIONS

A claim for priority under 35 U.S.C. §119 is made to Korean Patent Application No. 10-2016-0043726 filed Apr. 8, 2015, in the Korean Intellectual Property Office, the entire contents of which are hereby incorporated by reference.

### BACKGROUND

Embodiments of the inventive concept described herein relate to a photonic radiator for emitting light wave to a free space, and more particularly, relate to a grating-structured photonic radiator for radiating light wave to a free space in purpose of widening a scanning angle of a light beam generated from a phased array of a photonic phased array antenna. A detailed scale of a grating proposed herein is designed based on the concept of nanophotonics because it is close or smaller than a wavelength of the light wave.

A photonic phased array antenna may be used as a light source of scanning a light beam for image scanning in an autonomous car or robot. The photonic phased array antenna for application to various sectors is usually preferred to have the functionality of small size, high efficiency of photonic beam radiation, clear beam formation, and wide beam scanning range. For miniaturization of various requirements for the functionality, there is a need for a configuration of a photonic phased array antenna structure based on semiconductor materials. Further, since the efficiency of light beam radiation, visibility, and scanning functions are highly dependent on a structure of photonic radiator, it is required to propose a practical structure of photonic radiator based on semiconductor materials.

Semiconductor materials include a silicon or compound semiconductor, a metallic thin film material, and a dielectric material such as silicon nitride or silicon oxide which is used for manufacturing photonic devices made of the silicon or compound semiconductor.

A foregoing invention (US Patent Application No. 2014/0192394 A1) about a nanophotonics-based photonic phased array antenna has proposed a photonic phased array antenna where a phase-controlled photonic device is integrated in a form of M×M′ matrix based on a semiconductor silicon material.

In the foregoing invention, while the photonic radiator (corresponding to the antenna element in this specification thereof) is formed of a grating structure, photonic radiators are arranged in a form of matrix, and directional couplers and optical delay lines are arranged between unit photonic radiators. As such, because devices with different functions are densely integrated in one unit cell, a space occupied by a grating structure of the photonic radiator becomes smaller and thereby the dimension of gratings accommodated in such a small space should be scaled down in the dimension of several μm. Accordingly, if the dimension of grating becomes smaller, it is difficult to obtain a high-performance beam because radiation efficiency of light wave is degraded.

A foregoing invention (PCT/KR2015/012199) made by the laboratory for the present application has proposed a phased array antenna capable of providing a photonic radiator part with a sufficient space as shown in FIG. 1. In FIG. 1, main elements forming the phased array antenna are basically consisting of a light source 100, optical power distributors 101-1 and 101-2, phase controllers 102, and photonic radiators 104. Waveguides 106 are connected between the elements. Additionally, the waveguide 106 is also connected between the phase controllers 102 and the photonic radiators 104. Since high density of the waveguide could generate a coupling effect between the waveguides, their arrangement is important and for the reason, the waveguide is divided into phase-feeding lines 103.

The phased array of FIG. 1 is characterized, for the purpose of securing a sufficient space in a longitudinal direction of the photonic radiator 104, in that the power distributors 101-1 and 101-2, the phase controllers 102, and the phase-feeding lines 103 are arranged out of a 1×M radiator array 105. As such, the foregoing invention proposed that it is possible to secure a sufficient space between adjacent 1×M radiator arrays, as well as achieving a second-dimensional (2D) beam scanning function, by implementing a (1×M)×L phased array by independently arranging L-numbered 1×M radiator arrays up and down.

Accordingly, the following embodiments propose a photonic radiator structure which sufficiently uses a space in a longitudinal direction of a rating structure suitable for such a (1×M)×L phased array.

### SUMMARY

Embodiments of the inventive concept provide a photonic radiator for securing a proper level of light beam radiation and a performance of phase-matched beam by including a grating structure.

Embodiments of the inventive concept further provide a photonic radiator for widening a range of a divergence angle of an output light wave, from a bidirectional input mode of light waves, and finally widening a scanning range of a phase-matched beam obtained through a phased array.

According to an embodiment, a photonic radiator used for a photonic phased array antenna includes a waveguide including a waveguide clad and a waveguide core using semiconductor materials, and a grating that radiate an output light wave to a space by using scattering of an input light wave incident in a direction of the waveguide.

The grating may be periodically formed upper or lower parts of the waveguide to generate the scattering of the input light wave, and wherein at least one dimension of a width, a period, or a depth of the grating may have a value within a diffraction limit that is a half of a wavelength of the input light wave, or have a value close to the diffraction limit by a range that is set in advance.

The width of the grating W_{g} may be adjusted to have a range of 0.3λ₀≦W_{g}≦5λ₀ with respect to a free space wavelength λ₀ of the input light wave to control a transverse divergence angle range of the output light wave

The period of the grating may be adjusted to control a longitudinal divergence angle of the output light wave.

The depth of the grating may be adjusted to control a longitudinal distribution of the output light wave.

At least one dimension of a width or a thickness of the waveguide core may have a value in a diffraction limit that is a half of a wavelength of the input light wave, or have a value close to the diffraction limit by a range that is set in advance.

A free space wavelength λ₀ of the input light wave may be ranged in 1 μm<λ₀<2 μm.

The photonic radiator may receive the input light wave in bilateral directions of the waveguide to widen a longitudinal divergence angle range of the output light wave.

According to an embodiment, a photonic radiator array formed of a photonic radiator includes a waveguide that includes a waveguide clad and a waveguide core using semiconductor materials, and a grating that radiates an output light wave to a space by using scattering of an input light wave incident in a direction of the waveguide, wherein the photonic radiator array is implemented with a plurality of photonic radiators, and wherein the number of the plurality of the photonic radiators is adjusted to control a transverse divergence angle of a phase-matched beam that is formed through phase interference between output light waves radiated respectively from the plurality of photonic radiators.

The number of periods of the gratings included in each of the plurality of photonic radiators may be adjusted to control the longitudinal divergence angle of the phase-matched beam that is formed through the phase interference between the output light waves radiated respectively from the plurality of photonic radiators.

According to an embodiment, a photonic phased array antenna may be implemented with an array of a plurality of photonic radiators. The photonic phased array antenna is configured with a photonic radiator includes a waveguide that includes a waveguide clad and a waveguide core using semiconductor materials and a grating that radiates an output light wave to a space by using scattering of an input light wave incident in a direction of the waveguide.

The photonic phased array antenna may provide a phase, which is increasing or decreasing, to the plurality of photonic radiators such that the plurality of photonic radiators have a uniform phase difference, and to steer a phase-matched beam by a phased array of the plurality of photonic radiators to a transverse direction in the space.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a schematic diagram illustrating main elements of a photonic phased array antenna proposed by a forgoing invention;

FIGS. 2A and 2B are schematic diagrams illustrating a basic structure of a photonic radiator according to an embodiment;

FIGS. 3A to 3D are diagrams to show diffraction patterns radiated from a single grating structure according to an embodiment;

FIGS. 4A and 4B are diagrams to show an effect of grating periods to divergence angles in a single grating structure according to an embodiment;

FIGS. 5A to 5C are diagrams to show a range of a far-field pattern radiated from a single grating structure according to an embodiment;

FIGS. 6A to 6E are diagrams to show a pattern of a phase-matched beam radiated from a grating-structured radiator array according to an embodiment;

FIGS. 7A to 7C are diagrams to show variation of a phase-matched beam by variation of the number of grating periods, N_{g}, in a radiator of a grating-structured radiator array according to an embodiment;

FIGS. 8A to 8E are diagrams to show a steering function of a phase matched beam by phase control in a grating-structured phased array according to an embodiment; and

FIG. 9 is a schematic diagram illustrating extension of longitudinal radiation range of an output light wave by bidirectional incidence in a grating structure according to an embodiment.

### DETAILED DESCRIPTION

Hereinafter, a grating-structured radiator according to embodiments of the inventive concept will be described below in conjunction with the accompanying drawings. These embodiments of the inventive concept are just described to show practical details without any intention for restricting and defining the scope of the inventive concept. All matters easily derivable from these embodiments of the inventive concept by those skilled in the art are construed as being included in the scope of the inventive concept.

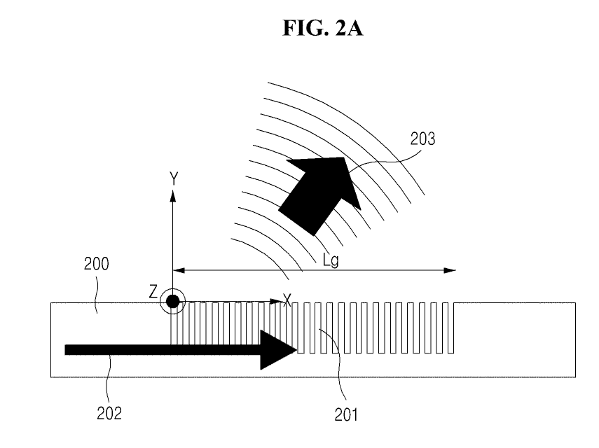

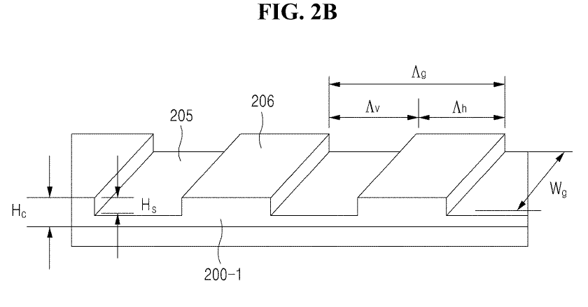

FIGS. 2A and 2B are schematic diagrams illustrating a basic structure of a photonic radiator according to an embodiment. In detail, FIG. 2A is a side sectional diagram of a photonic radiator and FIG. 2B is an overview diagram showing a structure of the photonic radiator.

Referring to FIGS. 2A and 2B, a grating 201 may be placed at the end of a waveguide core 200 and formed in upper or lower parts of the waveguide core 200. The grating 201 may not be restricted to the upper or lower parts of the waveguide core 200 in location and may be formed even around sides of the waveguide core 200. A waveguide may be made of general semiconductor or insulator materials and may be fabricated in a rib-type or a channel-type structure. In this case, for the purpose of showing main design parameters, a channel-type waveguide is exemplarily illustrated only with a core part of the waveguide and the grating 201 is illustrated as being formed on the upper part of the waveguide core 200.

If an input light wave 202 is incident through the waveguide core 200, scattering may occur in the grating 201 and then an output light wave 203 may be radiated to an outer space forming a diffraction pattern spread out over a relatively wide range thereof.

In this case, a wavelength of the input light wave 202 may be selected within a wavelength band providing a small optical loss in the waveguide. For example, in the case that the waveguide core 200 is made of silicon, a wavelength of the input light wave 202 may be preferred to be in a wavelength band of 1.1 μm˜8.5 μm (wavelength in a free space).

The main design parameters (geometric parameters) of the photonic radiator may include a period Λ_{g} of the grating 201, a width Λᵥ of a valley 205 of a unit grating 201, a width Λₕ of a hill 206 of the unit grating 201, the number of periods N_{g} of the grating 201, a length L_{g}=Λ_{g}×N_{g} of the grating 201, a depth H_{g} of the grating 201 (a depth of a valley of the grating 201), a thickness H_{c} of a waveguide core 200-1 of the grating 201, a width W_{g} of the grating 201 of the waveguide core 200, and a pitch Dᵣ between unit radiators.

For this structure, embodiments of the inventive concept provides a particular grating structure which is obtainable with proper levels in a radiation efficiency of light wave, a range of a divergence angle, a pattern of beam formed by a phased array, and a range of a scanning angle.

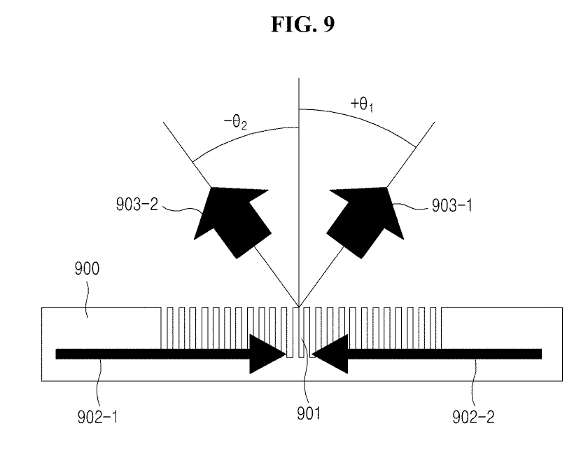

Additionally, while FIG. 2A illustrates that the input light wave 202 is incident only in a one direction (form the left to the right), an incident direction may not be restricted thereto. As an alternative for further widening a scanning angle range, it may be permissible to propose an antenna structure where an input light wave is bidirectional incident on the grating 201. This will be described later in detail with reference to FIG. 9.

A divergence angle of a far-field of the output light wave 203 radiated from the grating 201 may be designed by using Equation 1 according to the diffraction principle.

λ₀/Λ_{g}=n_{eff}−n_{c} sin θ [Equation 1]

In Equation 1, λ₀ denotes a central wavelength of the input light wave 202 in a free space, Λ_{g} denotes a period of the grating 201, nay denotes an effective refractive index of the waveguide 200 including the grating 201 (an effective refractive index of the whole waveguide including a clad), n_{c} denotes a refractive index of the clad covering the waveguide core 200 where the grating 201 is formed, and θ denotes a divergence angle corresponding to a wave center (e.g., an angle from a normal direction of a grating surface) at which the maximum light intensity appears in a diffraction pattern scattered from the grating 201.

In this case, the effective refractive index n_{eff} may be determined depending on a structure of the waveguide based on refractive indexes of the waveguide materials for a wavelength of a light wave. Additionally, a refractive index of the clad may be expressed with n_{c}=1 in the case that the grating 201 is exposed to a free space. This equation is based on a classical diffraction theory, but such a classical diffraction theory has a problem in properly representing the case that geometric dimensions such as a period of the grating 201, and a width and a thickness of the waveguide core are equal to or smaller than a diffraction limit, that is, the case that the geometric dimensions are close to or smaller than a half wavelength (λ₀/2) of the input light wave 202. Accordingly, for embodiments of the inventive concept, it is possible to generally interpret radiation characteristics of a beam through a numerical simulation in a small-scale region belong to a nanophotonics area.

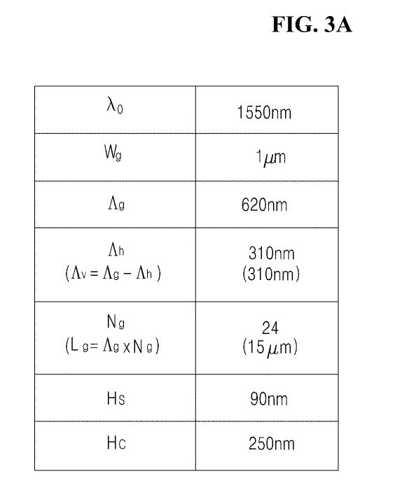

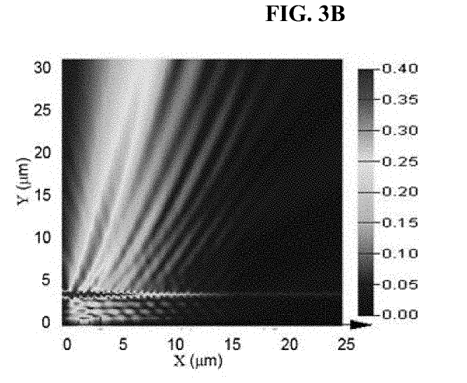

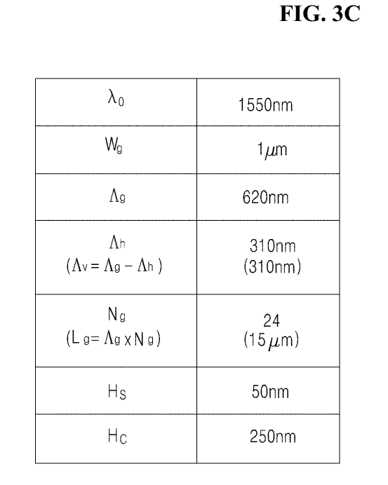

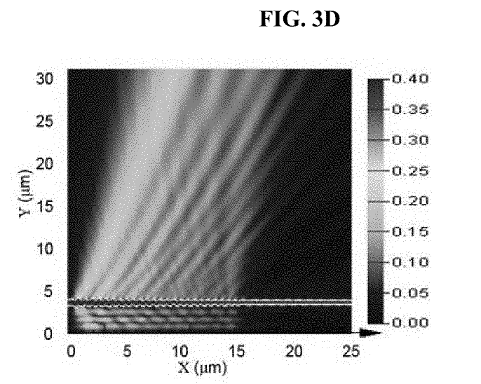

FIGS. 3A to 3D are diagrams to show diffraction patterns radiated from a single grating structure according to an embodiment. In detail, FIGS. 3A and 3C show design parameters for two types of grating structures which have different depths Hₛ of grating valleys, and FIGS. 3B and 3D show simulation results of near-field patterns radiated from their corresponding grating structures (e.g., FIGS. 3B and 3D show radiation characteristics simulated with Finite-Difference Time-Domains (FDTD) for their corresponding grating structures). That is to say, FIGS. 3A to 3D are examples to show the effect of a main parameter which can control the distribution of an output light wave along the longitudinal direction that is a lengthwise direction of the grating.

Referring to FIGS. 3A to 3D, the radiation characteristics of FIGS. 3B and 3D exhibit near-field patterns of electric fields for light waves on a longitudinal section of the grating (on the X-Y plane of FIG. 2A), showing the field intensities in colors (with contrast of light and darkness in black and white images). As shown in FIGS. 3B and 3D, the fields are divided into different segments along a longitudinal direction, which is caused by differences between scattering rates thereof due to irregularity of the grating surface. The overall intensity of the fields may be weakened along the lengthwise direction of the grating.

In the result of FIG. 3B, most of the field, (more than 80%), is radiated from the front part within 5 μm (within N_{g}=8) in the whole length 15 μm (in whole period N_{g}=24) of the grating However in the result of FIG. 3D, a considerable amount of the field is spread out to the rear part of the grating. This difference is raised from a difference between valley depths Hₛ of the gratings. In other words, if a valley depth of the grating is deep, a radiated field may be concentrated on the front part of the grating due to a larger scattering effect. If a valley depth of the grating is shallow, a radiated field may be dispersed to the rear part of the grating due to a smaller scattering effect.

In this case, since the whole radiation efficiency is degraded if the field is concentrated on the front part of the grating, it is preferred to extend a scattering up to a sufficient range in a longitudinal direction of the grating as shown in FIG. 3D in order to raise the whole radiation efficiency.

A longitudinal distribution of a radiation field may be affected mainly from a valley depth of the grating, but also affected from a wavelength of a light wave, a thickness of the waveguide core, and a width of the grating. Considering the effect of these parameters in such scales as exemplified in FIGS. 3A and 3C, a portion roughly equal to or larger than 80% of the electric field of the output light may be radiated to a space within 8 periods of the grating in the case that a relative ratio of a valley depth of the grating to a thickness of the waveguide core is equal to or higher than 1/4. On the other hand, a portion roughly equal to or larger than 80% of the electric field of the output light may be radiated to a space until a range equal to or larger than 5 or 8 periods of the grating in the case that a relative ratio of a valley depth of the grating to a thickness of the waveguide core is equal to or lower than 1/4.

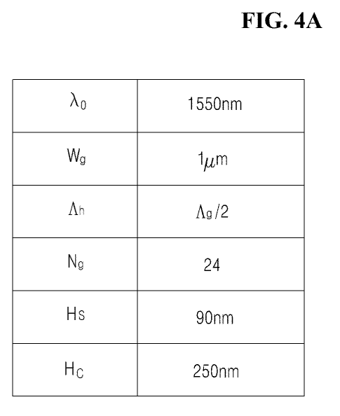

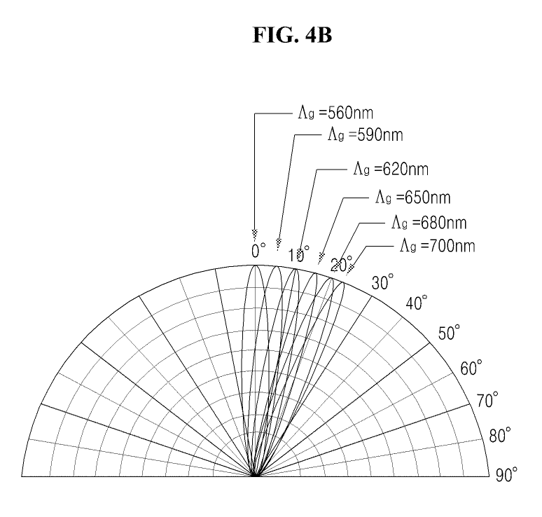

FIGS. 4A and 4B are diagrams to show an effect of grating periods to divergence angles in a single grating structure according to an embodiment. In detail, FIG. 4A shows values of design parameters, and FIG. 4B shows simulation results for variation of a longitudinal divergence angle (corresponding to θ) of a far-field depending on variation of a period Λ_{g} of the grating in the condition that the design parameters of FIG. 4A are fixed.

Referring to FIGS. 4A and 4B, it can be seen from FIG. 4B that a divergence angle may be variable in a wide range with small variation of the grating period Λ_{g}. Additionally, in a structure with the parameters of FIG. 4A, an effective refractive index n_{eff} is about 2.8 and is not affected greatly from a period of the grating. In this case, the effective refractive index is sensitive to a width W_{g} of the waveguide core where the grating is formed. For the structure of FIG. 4A, in the case that a refractive index of semiconductor materials of the waveguide core is 3.5 and a width of the waveguide core is ranged in 0.3λ₀≦W_{g}≦5λ₀, an effective refractive index of the waveguide where the grating is formed may be ranged in 2.5<n_{eff}<3.0.

Referring to Equation 1, a divergence angle θ tends to be determined by a relative difference between an effective refractive index n_{eff} and a relative ratio λ₀/Λ_{g} which is a ratio of a wavelength of a free space to a period of the grating. In regard to this tendency, when the λ₀/Λ_{g} roughly varies in a value of n_{eff}≧λ₀/Λ_{g}≧0.6 n_{eff} in scales close to values of the parameters exemplified in FIG. 4A, a longitudinal divergence angle range may vary in 0°˜60°. It is possible to reduce the ratio λ₀/Λ_{g} narrower than the range to enlarge the longitudinal radiation angel range to a value equal to or larger than 60°, but it degrades radiation efficiency and then decreases usability thereof.

Now, parameters affecting a transverse radiation range of a single radiator will be described hereinbelow. Based on the classical Gaussian beam theory, a transverse angle range 2Φᵣ of a light wave emitted from a single radiator may be approximated by Equation 2.

$$2 {Φ}_{r} = \frac{2 {λ}_{0}}{π {W}_{g}} \qquad [ Equation 2 ]$$

In Equation 2, it is assumed that radiation of the light wave from the grating in the transverse direction follows the Gaussian propagation and the aperture size emitting the Gaussian beam to the transverse direction is approximated with the width W_{g} of the grating in the grating-structured photonic radiator.

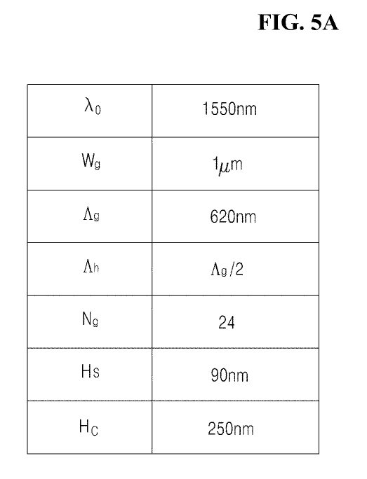

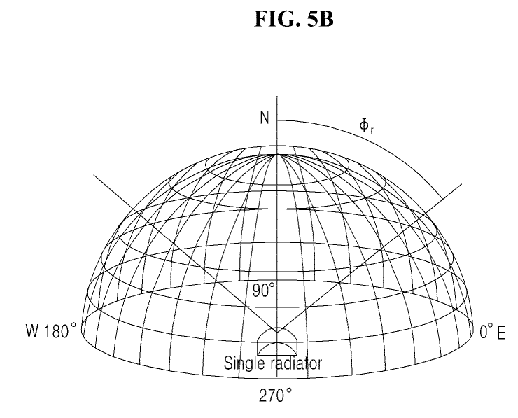

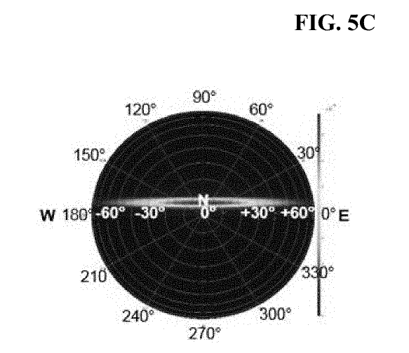

According to the basic expression of Equation 2, a transverse range of a far-field radiated from a single grating structure may be principally determined by a relative ratio of a wavelength to a width of the grating, that is, λ₀/W_{g}, and may be widened as a relative width of the grating becomes narrower. Equation 2 simply represents only a general relation of the parameters and a radiation range of a structure according to an embodiment will be confirmed by a simulation of numerical analysis as shown in FIGS. 5A to 5C.

FIGS. 5A to 5C are diagrams to show a range of a far-field pattern radiated from a single grating structure according to an embodiment. In detail, FIG. 5A shows design parameters, FIG. 5B shows a 3D view of a hemispherical spatial coordinate system and FIG. 5C shows a simulation result which represents a radiation range as a planar projection model in the hemispherical spatial coordinate system.

Referring to FIGS. 5A to 5C, a structure applied to FIGS. 5A to 5C is a case to design a wide transverse range and the main design parameters including W_{g} are the same with FIG. 4A. But, a period of the grating is selected as Λ_{g}=620 nm in which a divergence angle is θ=10.4°. In the structure of FIG. 5A, a main parameter determining a transverse range is λ₀/W_{g} and this parameter is examples as 3.1. In FIGS. 5B and 5C, a direction of W(180°)−E(0°) corresponds to a transverse direction of the grating (the direction “Z” in FIG. 2A) and the direction “N” corresponds to a normal direction of the grating (the direction “Y” in FIG. 2A, θ=0° in Equation 1). In the exemplary structure of FIG. 5B, since the divergence angle is θ=10.4°, the radiation pattern of FIG. 5C is slightly inclined toward 90° from the line of W(180°)−E(0°). An electric field radiated from the grating is distributed similar to a cone having an oval section as shown in FIG. 5B, and radiated wider along the transverse direction (the direction of W(180°)−E(0°)) than the longitudinal direction (the direction of 90°-270°) as shown in FIG. 5C. With respect to a distribution of light intensity in a direction of W-N-E in FIG. 5B, the light intensity is maximized in the vertical direction (the direction “N”) and a radiation range Φᵣ, which is represented with the angle where the light intensity falls down to 1/e² of the maximum intensity (1/e of the maximum electric field; in this case, the exponent is e≈2.72), exceeds a range of ±45° in the transverse direction of the grating. This result means that it is possible to widen the maximum beam steering range near to ±45° in the transverse direction in the case forming a phased array with a grating structure (λ₀/W_{g}=3.1) according to an embodiment of the inventive concept.

Next, parameters affecting the performances of a phase-matched beam in the case of forming an array with the photonic radiator will be described hereinbelow. In a 1×M radiator array, one or more phase-matched beams may be formed due to interference between output light waves radiated respectively from photonic radiators of the 1×M radiator array. A divergence angle 2η_{∥} of the phase-matched beam in the transverse direction may be approximated by Equation 3 based on the classical Gaussian beam theory.

$$2 η // = \frac{2 {λ}_{0}}{π ( {W}_{g} \cdot M )} \qquad [ Equation 3 ]$$

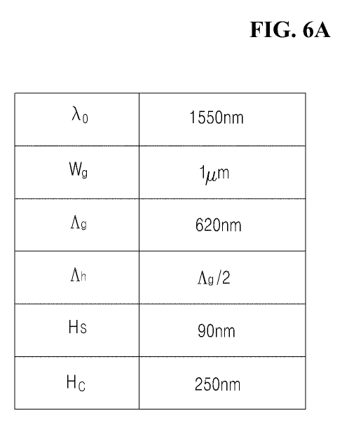

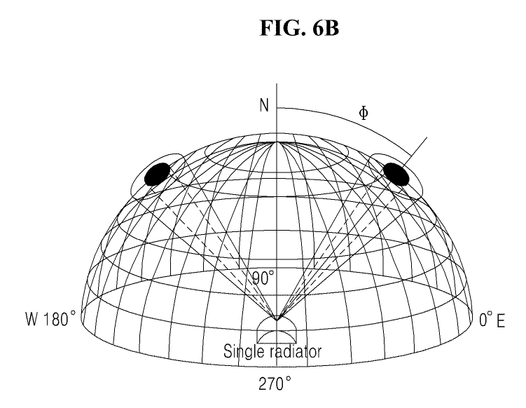

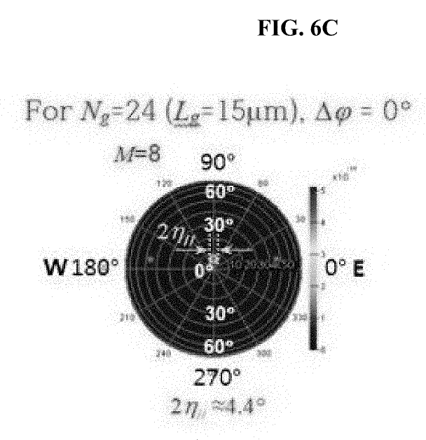

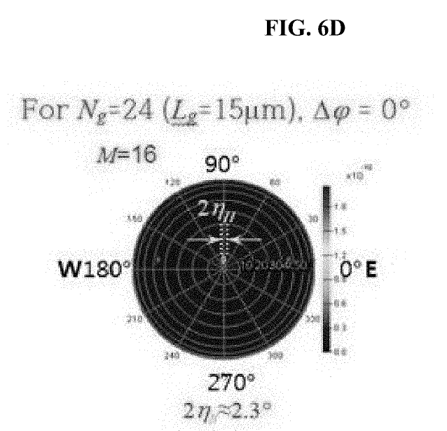

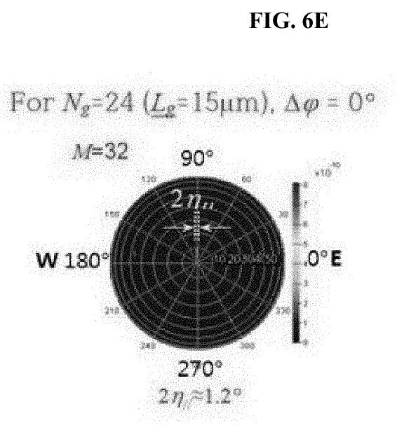

In Equation 3, W_{g}·M is a parameter determined under assumption that the aperture size emitting the Gaussian beam to the transverse direction is corresponding to the width of the whole array. According to the basic expression of Equation 3, main parameters affecting a transverse beam-forming range of phase-matched beams are a relative ratio λ₀/W_{g} of a wavelength to a width of the grating, and the number “M” of radiators of the array. Especially, as the number “M” of the radiators increases, Equation 3 goes to result in narrowing the transverse divergence angle 2η_{∥} of the phase-matched beam. Equation 3 simply represents only a general relation of the parameters and a further detailed form will be confirmed by a simulation of numerical analysis as shown in FIGS. 6A to 6E.

FIGS. 6A to 6E are diagrams to show a pattern of a phase-matched beam radiated from a grating radiator array according to an embodiment. In detail, FIGS. 6A to 6E shows a detailed result about an effect of the number “M” of a 1×M radiator array, against a behavior of a phase-matched beam in the case of forming the 1×M radiator array in a grating structure according to an embodiment. In other words, FIGS. 6A to 6E show simulation results for patterns of phase-matched beam radiated from a phased array in the case of forming the phased array of 1×M array in a grating structure according to an embodiment and fixing a phase difference between radiators to Δφ=0°.

In detail, FIG. 6A shows values of design parameters and FIG. 6B is a schematic diagram illustrating a beam radiation pattern in a spatial coordinate system. FIGS. 6C to 6E show simulation results for variation of a phase-matched beam pattern according to the number “M” of the radiators in the array.

Referring to FIGS. 6A to 6E, the radiator's design parameters exemplified in FIG. 6A are the same as the unit design parameters exemplified in FIG. 5A. Especially, the parameter λ₀/W_{g} is the same as that of FIG. 5A, and the number of gratings is exemplified as N_{g}=24. From FIGS. 6C to 6E, it can be seen that as the number “M” of the radiators increases to 8, 16, and 32, a transverse divergence angle η_{∥} of a phase-matched beam becomes narrower to 4.4°, 2.3°, and 1.2°. According to a result of simulation result using the aforementioned the condition, it is possible to further narrow η_{∥} equal to or smaller than 0.8° in the case that the number “M” is equal to or larger than 64.

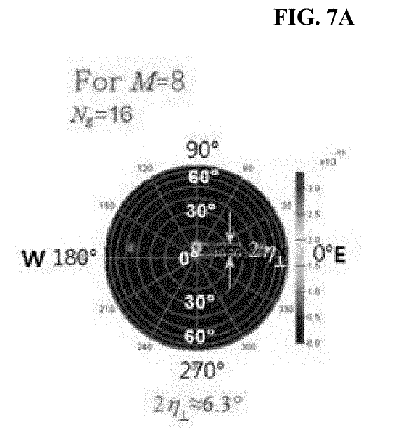

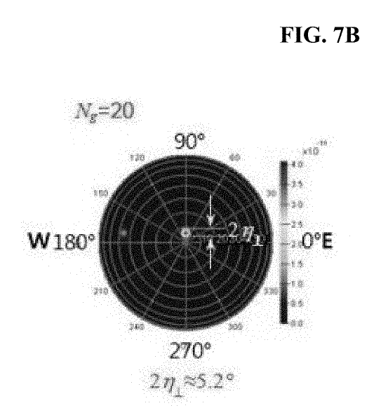

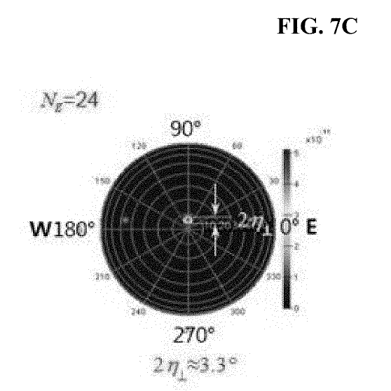

Hereupon, the narrowing of a beam divergence angle means that it is permissible to improve special resolution during an image scanning. Accordingly, adjusting transverse resolution may be performed by varying the number “M” of the radiator array. For this operation, adjusting a longitudinal divergence angle of a phase-matched beam, that is, adjusting longitudinal resolution, may be performed with L_{g}, which is a length of the grating of the array, as shown in FIGS. 7A to 7C.

Next, parameters affecting a longitudinal divergence angle of a phase-matched beam, in the case of forming an array with the radiators, will be described hereinbelow. A longitudinal divergence angle 2η_{⊥} of a phase-matched beam may be approximated by Equation 4 based on the classical Gaussian beam theory.

$$2 {η}_{⊥} = \frac{2 {λ}_{0}}{π {L}_{g}} = \frac{2 {λ}_{0}}{π ( {N}_{g} \cdot {Λ}_{g} )} \qquad [ Equation 4 ]$$

Equation 4 is similar to Equation 2 and is derived from the assumption that a longitudinal divergence angle of a phase-matched beam is determined by a longitudinal aperture size to emit the Gaussian beam, that may be corresponding to L_{g}. According to Equation 4, a transverse range of a far-field radiated from a single grating structure may be determined by a ratio of a wavelength to a width of the grating, that is, λ₀/L_{g}, and a longitudinal divergence angle 2η_{⊥} may be narrower as the relative ratio λ₀/L_{g} becomes smaller. A length of the grating is given by L_{g}=N_{g}·Λ. Accordingly, the transverse resolution may be adjusted by a length of the grating, L_{g} (or N_{g}). Equation 4 simply represents only a general relation of the parameters and a radiation range of a structure corresponding to a nanophotonics area according to an embodiment of the inventive concept will be confirmed by a simulation of numerical analysis as shown in FIGS. 7A to 7C.

FIGS. 7A to 7C are diagrams to show variation of a phase-matched beam by variation of the number of grating periods, N_{g}, in a radiator of a grating-structured radiator array according to an embodiment. In detail, FIGS. 7A to 7C show simulation results about variation of a longitudinal divergence angle, 2η_{⊥}, of a phase-matched beam according to variation of the number N_{g} of grating periods. Main design parameters applied to FIG. 7A are the same with the design parameters of FIG. 6A, and the number of radiators of a photonic radiator array is exemplified with M=8. From exemplarily shown in FIGS. 7A to 7C, it can be seen that a longitudinal divergence angle 2η_{⊥} becomes narrower to 6.3°, 5.2°, and 3.3° as the number of grating periods, N_{g}, increases to 16, 20, and 24 (as a length L_{g} becomes longer), respectively, and longitudinal resolution can be improved thereby.

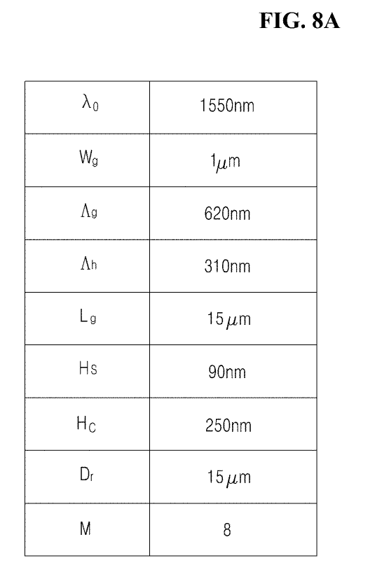

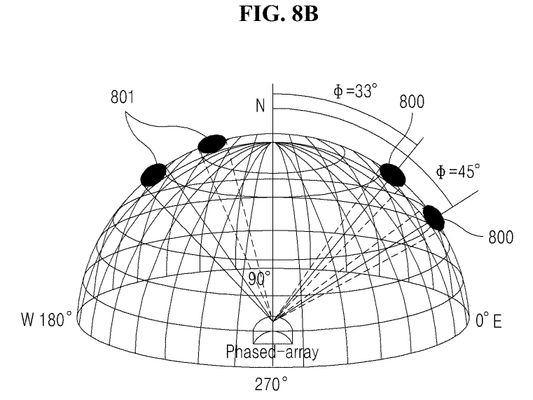

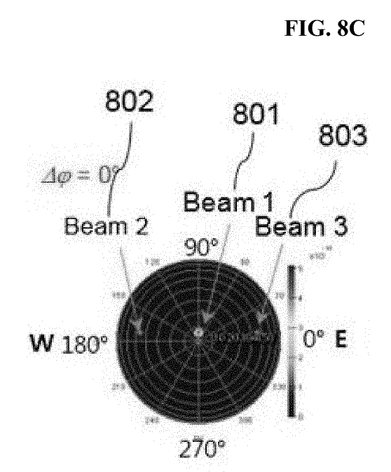

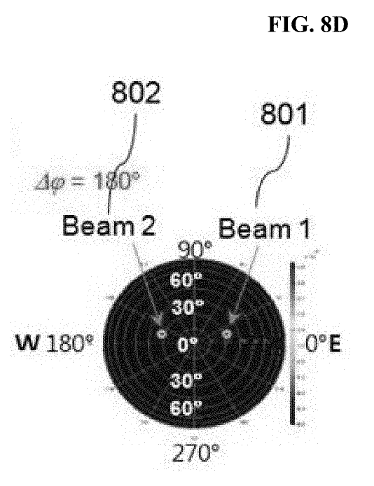

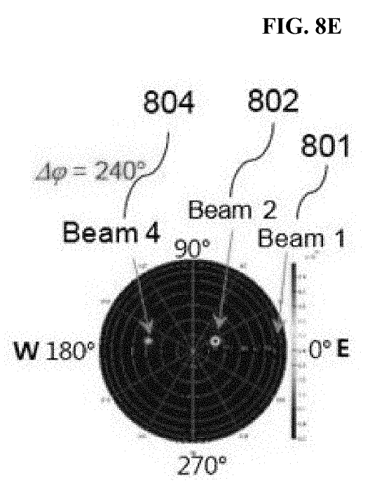

FIGS. 8A to 8E are diagrams to show a steering function of a phase-matched beam by phase control in a grating-structured phased array according to an embodiment. In detail, FIG. 8A shows values of design parameters, FIG. 8B is a schematic diagram illustrating a beam steering feature in a hemispherical spatial coordinate system, and FIGS. 8C to 8E show simulation results showing a result of steering phase-matched beams.

In the case that a phase difference between neighboring radiators is Δφ=0°, as shown in FIG. 8C, a phase-matched beam 1 (801) with strong light intensity is formed close to the center, that is, close to the direction “N”. In the example of FIG. 8C, other two phase-matched beams with weak light intensities, namely, beam 2 (802) and beam 3 (803), are formed at both outer sides close to the directions “W” and “E”. As can be seen from comparison between FIGS. 8C and 8D, if a phase difference, Δφ, is enlarged from 0° to 180°, the beam 1 (801) shifts to the direction “E” and the beam 2 (802) moves to the center (the direction “N”) from the direction “W”. During this shift, light intensity of the beam 1 (801) becomes gradually weaker and light intensity of the beam 2 (802) at the direction “W” becomes gradually stronger. As shown in FIG. 8E, if a phase difference goes to be equal to or larger than 180°, the beam 1 (801) and the beam 2 (802) further move toward the direction “E” and the most portion of the field is transferred to the beam 2 (802). Additionally, a beam 4 (804) newly appears at the direction “W”. As aforementioned, several beams may be steered during a phase modulation process and transitions of light wave field between the beams may vary light intensity. Among such several beams, the beam with the strongest light intensity is defined as a 0^{th}-order beam and other outer beams are defined as high-order beams.

From the results shown in FIGS. 8A to 8E, especially as shown in FIG. 8B, in the case of varying a phase difference in a range of 0≦Δφ≦2π and using all of the 0^{th}-order beam and the high-order beam in a phased array structure according to an embodiment of the inventive concept, the maximum transverse range Os may exceed ±45°. In this case, if a steering angle becomes much larger, it may cause a field of the high-order beam to be much weaker. Accordingly, for the purpose of maintaining intensity of light beams on an appropriate level, it is preferred to vary a phase difference in a range −π≦Δφ≦+π and to use only the 0^{th}-order beam. According to this manner, the maximum transverse range of the beam steering, Φₛ′, varies in a range −π≦Δφ≦+π and is scaled down to a half of the maximum transverse range of the aforementioned manner that is Φₛ′=Φₛ/2.

FIG. 9 is a schematic diagram illustrating longitudinal extension of an output light wave by bidirectional incidence in a grating structure according to an embodiment.

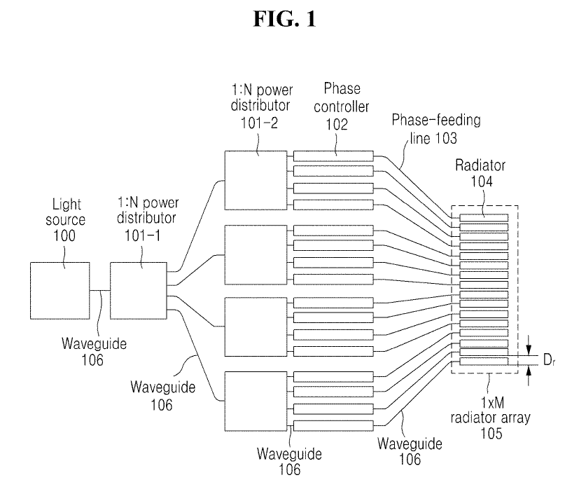

Referring to FIG. 9, if a grating 901 is designed to set a divergence angle of an output light wave 903-1 to +θ₁ in the case that an input light wave 902-1 is incident in a direction from the left to the right, an output light wave 902-2 may be radiated to the opposite side to have a divergence angle of −θ₂ in the case that another input light wave 902-2 is incident from the right to the left. Accordingly, since the divergence angles can be set to the two angles of +θ₁ and −θ₂ by making the input light waves 902-1 and 902-2 incident in bidirection, it is possible to extend a longitudinal radiation range. A configuration of a phased array antenna requiring bidirectional light incidence may be simply implemented by arranging devices, which form the unidirectional incident phased array antenna of FIG. 1, in a form of symmetrical mirror. In detail, the elements, such as the light source 100, the power distributers 101-1 and 101-2, the phase controller 102, the phase-feeding lines 103, and the photonic radiator 104, are also arranged at the right side in a form of symmetrical mirror, and the right phase-feeding lines are connected to the right side of the radiator.

While the embodiments described above in conjunction with FIGS. 3A to 8E are exemplified such that a wavelength of a free space is 1,550 nm for a silicon waveguide core, the embodiments may not be restricted thereto. A material of the waveguide core may be made of various materials having refractive indexes close to that of silicon and the aforementioned scaling mechanism may be applied by setting a wavelength of a free space to a proper wavelength domain. For example, it is possible to apply the aforementioned trend in a wavelength ranged in 1,100 nm<λ₀<2,000 nm in a silicon waveguide. And a width of the grating, W_{g}, which is a main parameter for the grating-structured photonic radiator, may be applicable with the aforementioned trend in a range 0.3λ₀<W_{g}<5λ₀.

While the embodiments described above are exemplified with a grating structure which is uniform in a grating, it is permissible to differently vary one or more parameters among the parameters of the grating structure, that is, Λ_{g}, Λᵥ, Hₛ, W_{g}, and so on, in a lengthwise direction of the grating. Additionally, while the embodiments described above are exemplified with the case that a light wave having a monochromatic wave is incident thereon, a light wave whose center wavelength is one or more or covers a wide range may be incident thereon.

Reference marks used for the aforementioned embodiments mean as follows.
X: longitudinal direction of grating
Z: transverse direction of grating
Y: normal direction of grating
Dᵣ: transverse pitch between unit radiators
λ₀: free space wavelength of input light wave
Λ_{g}: period of grating
Λᵥ: valley width of unit grating
Λₕ: hill width of unit grating
L_{g}: length of grating
N_{g}: the number of periods of grating
H_{c}: thickness of waveguide core of grating
Hₛ: valley depth of grating
W_{g}: width of grating in waveguide core
M: the number of radiators in array
n_{eff}: effective refractive index of waveguide where grating is formed
n_{c}: refractive index of clad covering waveguide where grating is formed
θ: longitudinal divergence angle of unit grating (angle from normal line)
Φᵣ: angle representing radiation range of far-field of unit grating (latitude in a hemispherical coordinate system)
Φ: transverse angle where phase-matched beam is formed in phased array
Φₛ: the maximum longitudinal steering angle of phase-matched beam obtainable by phase control in phased array
Δφ: phase difference between unit radiators
2η_{∥}: transverse divergence angle of phase-matched beam in phased array
2η_{⊥}: longitudinal divergence angle of phase-matched beam in phased array

According to embodiments of the inventive concept, it is possible to provide a photonic radiator for securing a proper level of light beam radiation and a performance of phase-matched beam by including a grating structure.

Additionally, according to embodiments of the inventive concept, it is also possible to provide a photonic radiator for widening a range of a divergence angle of an output light wave, in a bidirectional light wave input mode, and finally widening a scanning range of a phase-matched beam obtained through a phased array.

While embodiments of the present disclosure have been shown and described with reference to the accompanying drawings thereof, it will be understood by those skilled in the art that various changes and modifications in form and details may be made therein without departing from the spirit and scope of the present disclosure as defined by the appended claims and their equivalents. For example, it may be allowable to achieve desired results although the embodiments of the present disclosure are performed in other sequences different from the descriptions, and/or the elements, such as system, structure, device, circuit, and so on, are combined or assembled in other ways different from the descriptions, replaced or substituted with other elements or their equivalents.

Therefore, other implementations, other embodiments, and equivalents of the appended claims may be included in the scope of the appended claims.

What is claimed is:

1. A photonic radiator used for a photonic phased array antenna, the photonic radiator comprising:
a waveguide including a waveguide clad and a waveguide core using semiconductor materials; and
a grating configured to radiate an output light wave to a space by using scattering of an input light wave incident in a direction of the waveguide.

2. The photonic radiator of claim 1, wherein the grating is periodically formed upper or lower parts of the waveguide to generate the scattering of the input light wave, and
wherein at least one dimension of a width, a period, or a depth of the grating has a value within a diffraction limit that is a half of a wavelength of the input light wave, or has a value close to the diffraction limit by a range that is set in advance.

3. The photonic radiator of claim 2, wherein the width of the grating is adjusted to have a range of 0.3λ₀≦W_{g}≦5λ₀ with respect to a free space wavelength λ₀ of the input light wave to control a transverse divergence angle range of the output light wave

4. The photonic radiator of claim 2, wherein the period of the grating is adjusted to control a longitudinal divergence angle of the output light wave.

5. The photonic radiator of claim 2, wherein the depth of the grating is adjusted to control a longitudinal distribution of the output light wave.

6. The photonic radiator of claim 1, wherein at least one dimension of a width or a thickness of the waveguide core has a value in a diffraction limit that is a half of a wavelength of the input light wave, or has a value close to the diffraction limit by a range that is set in advance.

7. The photonic radiator of claim 1, wherein a free space wavelength λ₀ of the input light wave is ranged in 1 μm<λ₀<2 μm.

8. The photonic radiator of claim 1, wherein the photonic radiator receives the input light wave in bidirection of the waveguide to widen a longitudinal divergence angle range of the output light wave.

9. A photonic radiator array formed of a photonic radiator comprising a waveguide that includes a waveguide clad and a waveguide core using semiconductor materials, and a grating that radiates an output light wave to a space by using scattering of an input light wave incident in a direction of the waveguide,
wherein the photonic radiator array is implemented with a plurality of photonic radiators, and
wherein the number of the plurality of the photonic radiators is adjusted to control a transverse divergence angle of a phase-matched beam that is formed through phase interference between output light waves radiated respectively from the plurality of photonic radiators.

10. The photonic radiator array of claim 9, wherein the number of periods of the gratings included in each of the plurality of photonic radiators is adjusted to control the longitudinal divergence angle of the phase-matched beam that is formed through the phase interference between the output light waves radiated respectively from the plurality of photonic radiators.

11. A photonic phased array antenna formed of a photonic radiator comprising a waveguide that includes a waveguide clad and a waveguide core using semiconductor materials, and a grating that radiates an output light wave to a space by using scattering of an input light wave incident in a direction of the waveguide,
wherein the photonic phased array antenna is implemented with an array of a plurality of photonic radiators.

12. The photonic phased array antenna of claim 11, wherein the photonic phased array antenna is configured to provide a phase, which is increasing or decreasing, to the plurality of photonic radiators such that the plurality of photonic radiators have a uniform phase difference, and to steer a phase-matched beam by a phased array of the plurality of photonic radiators to a transverse direction in the space.
